(19) United States
(12) Patent Application Publication
(10) Pub. No.: US 2006/0020470 A1
(43) Pub. Date: Jan. 26, 2006

(54) Interactive speech synthesizer for enabling people who cannot talk but who are familiar with use of picture exchange communication to autonomously communicate using verbal language

(76) Inventors: Glen Dobbs, Woodbury, CT (US); Kevin Miller, Avon, CT (US)

Correspondence Address: CHARLES E. BAXLEY, ESQ., 90 JOHN STREET, THIRD FLOOR, NEW YORK, NY, 10038, US

(21) Appl. No.: 11/180,061

(22) Filed: Jul. 13, 2005

Related U.S. Application Data
(60) Provisional application No. 60/589,910, filed on Jul. 20, 2004.

(51) Int. Cl. G10L 21/06

(52) U.S. Cl. 704/271

(57) ABSTRACT

An interactive speech synthesizer for enabling people who cannot talk but who are familiar with use of picture exchange communication to autonomously communicate using verbal language. A microcontroller, at least one tag reader, and an audio output device are disposed at a housing, while at least one encoded tag is replaceably attached to the housing. The at least one tag reader reads data from an associated encoded tag, which has been replaceably attached thereat, to form a coded signal and transmits the coded signal to the microcontroller that looks up a sound bit file corresponding to the coded signal and sends the sound bit file to the audio output device to convert into sound, thereby allowing a sound corresponding to the selected tag to be produced to thereby generate, automatically and sequentially, unique audible information associated with the data of each encoded tag.

### 1. CROSS REFERENCE TO RELATED APPLICATIONS

The instant application is a non-provisional application claiming priority from provisional application No. 60/589,910, filed Jul. 20, 2004, and entitled PICTURE EXCHANGE BINDER WITH TALKING BOX.

### 2. BACKGROUND OF THE INVENTION

A. Field of the Invention

The present invention relates to an interactive speech synthesizer, and more particularly, the present invention relates to an interactive speech synthesizer for enabling people who cannot talk but who are familiar with use of picture exchange communication to autonomously communicate using verbal language.

B. Description of the Prior Art

Non-vocal mentally handicapped persons have extreme difficulty in communicating even basic desires and needs to those who are charged with their care. This results in a great deal of frustration—both for the handicapped person and for those who care for them.

Numerous innovations for speech synthesizers have been provided in the prior art that will be described below. Even though these innovations may be suitable for the specific individual purposes to which they address, however, they differ from the present invention.

(1) U.S. Pat. No. 4,465,465 to Nelson.

For example, U.S. Pat. No. 4,465,465 issued to Nelson on Aug. 14, 1984 teaches a communications device for use by severely handicapped persons having speech impairments and capable of only spastic movements. The device includes a housing in which speech reproduction apparatus is located for storing and reproducing pre-recorded audio message segments. The exterior of the housing has a nearly horizontal front portion on a console on which three relatively large—approximately 5″ times 5″—pressure-operated paddle switch actuator members are located. A vertical display panel is located immediately behind the paddle actuators and has on it visual aid cards that have a symbol identical to the recorded message that is to be reproduced by actuation of the appropriate paddle. Pressure on the selected paddle closes a switch, which turns on a light associated with the selected visual aid card and also actuates the reproduction of an audio message corresponding to the visual aid card.

(2) U.S. Pat. No. 4,681,548 to Lemelson.

Another example, U.S. Pat. No. 4,681,548 issued to Lemelson on Jul. 21, 1987 teaches an electronic system and method employing a plurality of record sheets or cards for teaching, training, quizzing, testing, and game playing when a person interacts therewith. In one form, a record card containing printed matter is inserted into a receptacle in a support and caused to move along a guide to an operating position where its printed face may be viewed and read. As it so travels, coded information on a border portion of the card is sensed to generate coded electrical signals that are applied to effect one or more functions, such as the programming of a computer, the selection of recordings from a memory, the generation of selected speech signals and sounds thereof, the control of a display or other interactive device or devices, the activation or control of a scoring means, or the selective activation of testing electronic circuitry. In another form, one of a plurality of record cards is selectively disposed in a U-shaped receptacle or the like by hand and a coded edge portion thereof is read to generate coded electrical signals to identify the card or its printed contents. The card or sheet is predeterminately positioned on one or more selected areas thereof—which are indicated by printing—are pressed by finger to close selected switches of a plurality of pressure sensitive switches to provide signal or circuit apparatus for performing such functions as answering questions, programming computing electrical circuits, selecting recordings from a memory, activating a display generating select speech from a memory, scoring, etc.

(3) U.S. Pat. No. 4,980,919 to Tsai.

Still another example, U.S. Pat. No. 4,980,919 issued to Tsai on Dec. 25, 1990 teaches a language practicing set that can under a recording state store voice signals by way of a voice synthesizer into a memory with different addresses through different coding holes on each of the message cards. Upon a replaying state the various coding holes on the message cards can be decoded to have the voice signal stored in various memory addresses selected and replayed through the voice synthesizer.

(4) U.S. Pat. No. 5,188,533 to Wood.

Yet another example, U.S. Pat. No. 5,188,533 issued to Wood on Feb. 23, 1993 teaches a three-dimensional indicia bearing unit including a voice synthesis chip, a battery, and an amplifier/speaker for synthesizing an audible sound for educational purposes, such as an interactive method for learning to read. The audible sound produced is the name and/or associated sound of the indicia bearing unit. The indicia bearing unit may be a letter, number, or alternatively, a short vowel or a long vowel form of a letter to produce the audible sound of the phonetic pronunciation of the letter. A plurality of unique indicia bearing units—organized in a selected sequence—form a set retained in a book like holder. The chip, battery, and amplifier/speaker may be self-contained within each indicia bearing unit. Alternatively, the indicia bearing unit may have a book configuration with several three-dimensional letters or numbers in a fixed or removable configuration, with the chip, battery, and amplifier/speaker being contained within the book-like unit. The removable three dimensional letters or numbers act as an electrical contact switch or have individual radio frequency transmitters sending a dedicated radio frequency signal to a receiver contained within the indicia bearing unit to activate the voice synthesis chip and produce an audible sound represented by the applicable indicia.

(5) U.S. Pat. No. 5,433,610 to Godfrey et al.

Still yet another example, U.S. Pat. No. 5,433,610 issued to Godfrey et al. on Jul. 18, 1995 teaches an educational device for children to accelerate learning from recognition, language acquisition, awareness of cause and effect, and association. The device houses discrete photos of environmental people, animals, and/or inanimate objects recognizable to the child, with each photo being operatively connected to a discrete pre-recorded message, such that upon a photo being pressed, the discrete and corresponding pre-recorded message is played. The child's learning is accelerated by repetitive use of the device.

(6) U.S. Pat. No. 5,556,283 to Stendardo et al.

Yet still another example, U.S. Pat. No. 5,556,283 issued to Stendardo et al. on Sep. 17, 1996 teaches an electronic learning system utilizing a plurality of coded cards on which sensory-information representations are provided to present pictorial-symbol information and/or language-symbol information. A housing contains card slots in combination with a visually and functionally distinctive button associated with each individual card slot and a button associated in an equal manner to all card slots, with a card being insertable in each of the card slots. The operator can cause the system to generate unique audible information associated with the sensory-information representation provided on any selected card by pressing the visually and functionally distinctive button associated with the card slot in which the card is inserted. The operator can also cause the system to generate—automatically and sequentially—unique audible information associated with the sensory-information representation provided on each inserted card, and depending on the type of cards installed, perform secondary functions as the individual cards are being accessed, such as mathematical computations, pattern recognition, and spelling accuracy, by pressing the visually and functionally distinctive button associated in an equal manner with all card slots, after which automatic tertiary functions take place, such as: the accuracy of the result of mathematical computations are accessed and an audible message is generated; an audible message equivalent to the combination of the installed cards is generated; and the accuracy of the spelling of words formed by individual cards is determined and an audible message is generated.

(7) U.S. Pat. No. 5,851,119 to Sharpe III et al.

Still yet another example, U.S. Pat. No. 5,851,119 issued to Sharpe III et al. on Dec. 22, 1998 teaches an interactive electronic graphics tablet utilizing two windows—one large window for the insertion of a standard sheet of paper or other material allowing the user to draw images on the paper and another smaller second window. A cartridge having various icons—such as animal images—is clicked into place in the smaller window. The device is configured such that the paper overlays a touch sensitive pad. Operation allows the user to assign any cell of the drawn page corresponding to XY coordinates to particular sounds correlated to the icons in the smaller second window by touching respective locations and icons.

(8) U.S. Pat. No. 6,068,485 to Linebarger et al.

Yet still another example, U.S. Pat. No. 6,068,485 issued to Linebarger et al. on May 30, 2000 teaches a computer-operated system for assisting aphasics in communication. The system includes user-controlled apparatus for storing data representing the user's vocalizations during a time interval, apparatus for associating the data stored in each of a plurality of such intervals with an icon, apparatus for ordering a plurality of such icons in a group representing a speech message, and apparatus for generating an audio output from the stored data represented by the icons in the group so as to provide a speech message.

(9) U.S. Pat. No. 6,525,706 to Rehkemper et al.

Still yet another example, U.S. Pat. No. 6,525,706 issued to Rehkemper et al. on Feb. 25, 2003 teaches an electronic picture book including a plurality of pages graphically depicting or telling a story. The book further includes an LCD screen and a speaker to provide a reader with animation sequences and sounds relating to the graphical pictures on the pages. A set of buttons is provided to trigger the animation sequences and sounds. While reading the book, each page indicates a button to depress. The reader—depressing the correct button—is then provided with animation sequences and sounds indicative to the graphic representations on the page.

(10) U.S. Patent Application Publication No. 20020193047 A1 to Weston.

Yet still another example, U.S. Patent Application Publication No. 20020193047 A1 published to Weston on Dec. 19, 2002 teaches a playmate toy or similar children's toy having an associated wireless, batteryless ID tag readable from and/or written to using a radio-frequency communication protocol. The tag is mounted internally within a cavity of the toy and thereby provides wireless communication of stored information without requiring removal and reinsertion of the tag. In this manner, a stuffed animal or other toy can be quickly and easily identified non-invasively without damaging the toy. Additional information—e.g., unique personality traits, special powers, skill levels, etc.—can also be stored on the ID tag, thus providing further personality enhancement, input/output programming, simulated intelligence, and/or interactive gaming possibilities.

(11) U.S. Patent Application Publication No. 20040219501 A1 to Small et al.

Still yet another example, U.S. Patent Application Publication No. 20040219501 A1 published to Small et al. on Nov. 4, 2004 teaches an interactive book reading system responsive to a human finger presence. The system includes a radio frequency scanning circuit, a control circuit, a memory, and an audible output device. The RF scanning circuit is configured to detect the presence of the human finger when the finger enters an RF field generated by the RF scanning circuit. The control circuit and the memory are in communication with the RF scanning circuit. The memory stores a plurality of audible messages. The audible output device is also in communication with the control circuit. The audible output device outputs at least one of the audible messages based on an analysis of the RF field performed by the control circuit when the finger enters the RF field.

It is apparent that numerous innovations for voice synthesizers have been provided in the prior art that are adapted to be used. Furthermore, even though these innovations may be suitable for the specific individual purposes to which they address, however, they would not be suitable for the purposes of the present invention as heretofore described.

### 3. SUMMARY OF THE INVENTION

An object of the present invention is to provide an interactive speech synthesizer for enabling people who cannot talk but who are familiar with use of picture exchange communication to autonomously communicate using verbal language that avoids the disadvantages of the prior art.

Briefly stated, another object of the present invention is to provide an interactive speech synthesizer for enabling people who cannot talk but who are familiar with use of picture exchange communication to autonomously communicate using verbal language. A microcontroller, at least one tag reader, and an audio output device are disposed at a housing, while at least one encoded tag is replaceably attached to the housing. The at least one tag reader reads data from an associated encoded tag, which has been replaceably attached thereat, to form a coded signal and transmits the coded signal to the microcontroller that looks up a sound bit file corresponding to the coded signal and sends the sound bit file to the audio output device to convert into sound, thereby allowing a sound corresponding to the selected tag to be produced to thereby generate, automatically and sequentially, unique audible information associated with the data of each encoded tag.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### 4. BRIEF DESCRIPTION OF THE DRAWING

The figures of the drawing are briefly described as follows:

FIG. 1 is a diagrammatic perspective view of the interactive speech synthesizer of the present invention for enabling people who cannot talk but who are familiar with use of picture exchange communication to autonomously communicate using verbal language;

FIG. 2 is an exploded diagrammatic perspective view of the interactive speech synthesizer of the present invention for enabling people who cannot talk but who are familiar with use of picture exchange communication to autonomously communicate using verbal language shown in FIG. 1; and

FIG. 3 a diagrammatic block diagram of the interactive speech synthesizer of the present invention for enabling people who cannot talk but who are familiar with use of picture exchange communication to autonomously communicate using verbal language shown in FIG. 1.

### 5. LIST OF REFERENCE NUMERALS UTILIZED IN THE DRAWING

10 interactive speech synthesizer of present invention for enabling people who cannot talk but who are familiar with use of picture exchange communication to autonomously communicate using verbal language
12 housing
14 microcontroller
16 at least one encoded tag
18 at least one tag reader
20 coil of each tag reader of at least one tag reader 18
22 audio output device
24 speaker of audio output device 22
26 memory
28 activation apparatus
30 at least one switch of activation apparatus 28
31 power management apparatus for interfacing with power supply 32
32 power supply
34 interface port for flashing new firmware and downloading new sound bit files into memory 26
36 microphone/amplifier for recording new sound bit files into memory 26
38 binder
40 portion of hook and loop fasteners on binder 38
42 symbolic picture on one side of each encoded tag of at least one encoded tag 16
44 mating portion of hook and loop fasteners on other side of each encoded tag of at least one encoded tag 16
46 dip switches
48 console of housing 12
50 recessed areas in console 48 of housing 12

### 6. DETAILED DESCRIPTION OF THE INVENTION

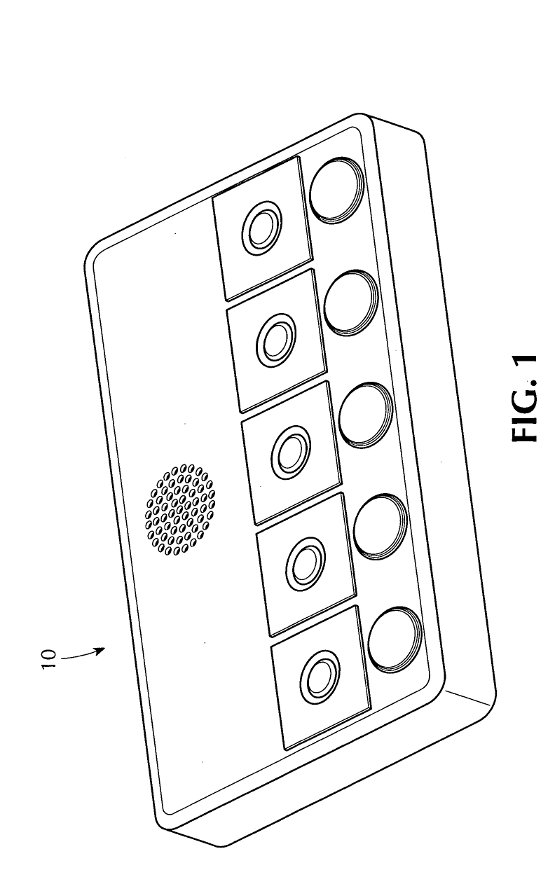

Referring now to the drawing, in which like numerals indicate like parts, and particularly to FIG. 1, which is a diagrammatic perspective view of the interactive speech synthesizer of the present invention for enabling people who cannot talk but who are familiar with use of picture exchange communication to autonomously communicate using verbal language, the interactive speech synthesizer of the present invention is shown generally at 10 for enabling people who cannot talk but who are familiar with use of picture exchange communication to autonomously communicate using verbal language.

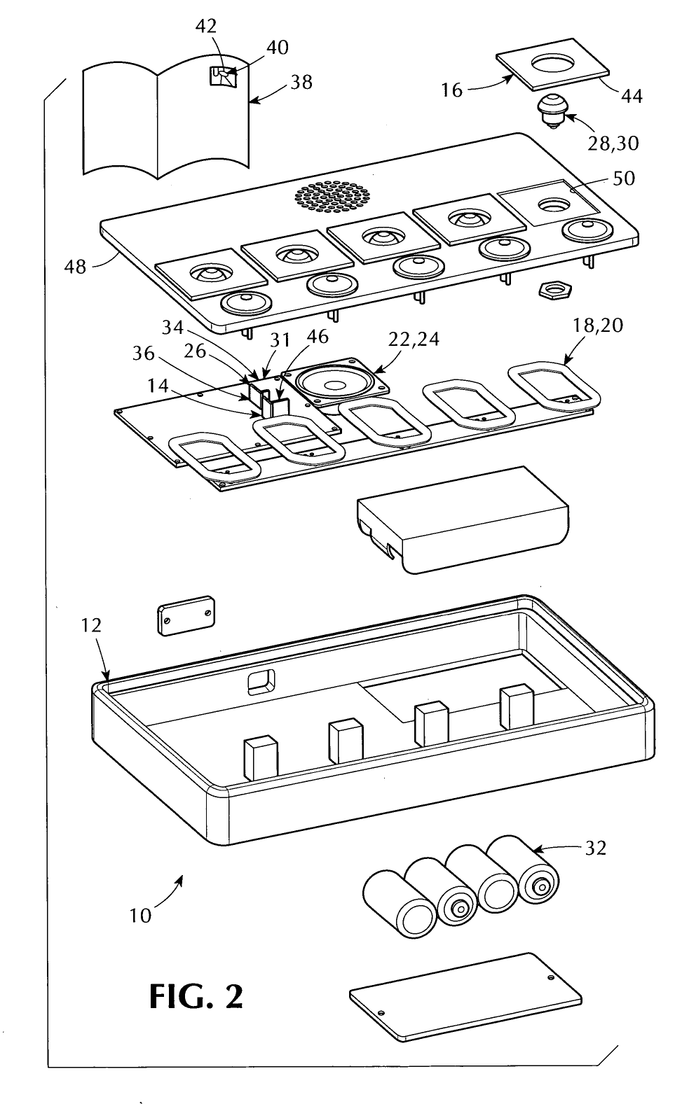

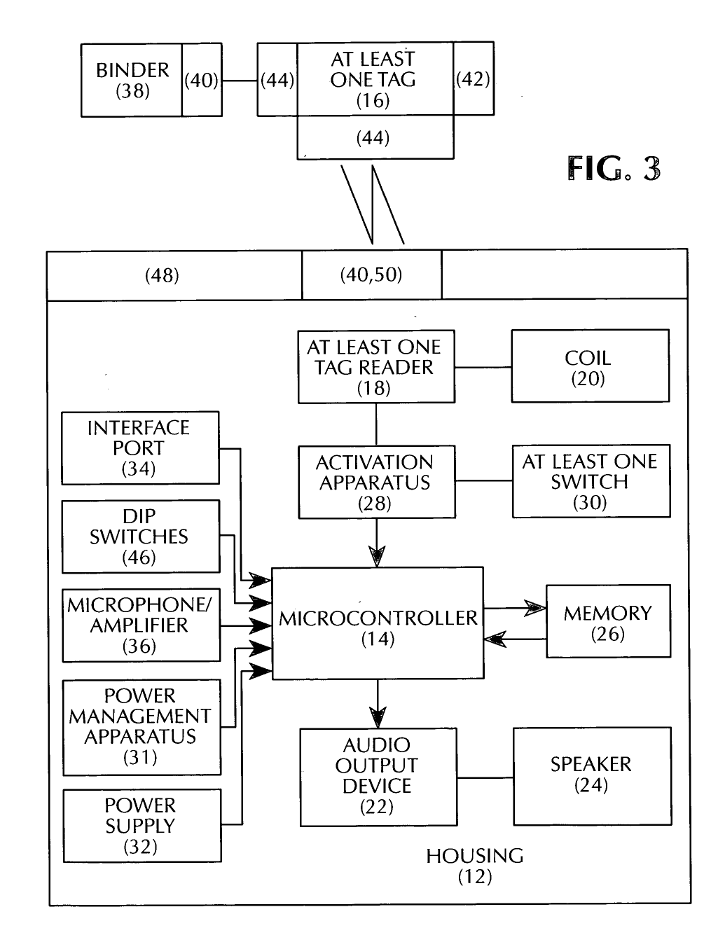

The configuration of the interactive speech synthesizer 10 can best be seen in FIGS. 2 and 3, which are, respectively, an exploded diagrammatic perspective view of the interactive speech synthesizer of the present invention for enabling people who cannot talk but who are familiar with use of picture exchange communication to autonomously communicate using verbal language shown in FIG. 1, and, a diagrammatic block diagram of the interactive speech synthesizer of the present invention for enabling people who cannot talk but who are familiar with use of picture exchange communication to autonomously communicate using verbal language shown in FIG. 1, and as such, will be discussed with reference thereto.

The interactive speech synthesizer 10 comprises a housing 12, a microcontroller 14, at least one encoded tag 16—preferably RFID, at least one tag reader 18—preferably a coil 20, and an audio output device 22—preferably a speaker 24. The microcontroller 14, the at least one tag reader 18, and the audio output device 22 are disposed at the housing 12, and the at least one encoded tag 16 is replaceably attached to the housing 12. The at least one tag reader 18 reads data from an associated encoded tag 16, which has been replaceably attached thereat, to form a coded signal and transmits the coded signal to the microcontroller 14 that looks up a sound bit file corresponding to the coded signal and sends the sound bit file to the audio output device 22 to convert into sound, thereby allowing a sound corresponding to the selected tag 16 to be produced to thereby generate, automatically and sequentially, unique audible information associated with the data of each encoded tag 16.

The interactive speech synthesizer 10 further comprises memory 26. The memory 26 is disposed at the housing 14 and stores the sound bit files—by addresses—to be looked up by the microcontroller 14.

The interactive speech synthesizer 10 further comprises activation apparatus 28—preferably at least one switch 30. The activation apparatus 28 is disposed at the housing 12, and when activated, activates the microcontroller 14 and the at least one tag reader 18 to read the data from an associated encoded tag 16, thereby triggering the sounds.

The interactive speech synthesizer 10 further comprises power management apparatus 31. The power management apparatus 31 is disposed at the housing 12, is for interfacing with a power supply 32—preferably batteries, and conserves power by allowing the interactive speech synthesizer 10 to remain in sleep mode until the activation apparatus 28 is activated.

The interactive speech synthesizer 10 further comprises an interface port 34—preferably USB. The interface port 34 is disposed at the housing 12 and is for flashing new firmware and downloading new sound bit files into the memory 26.

The interactive speech synthesizer 10 further comprises a microphone/amplifier 36. The microphone/amplifier 36 is disposed at the housing 12 and is for recording new sound bit files into the memory 26.

The interactive speech synthesizer 10 further comprises a binder 38. The binder 38 replaceably contains the at least one encoded tag 16, and has a portion 40 of hook and loop fasteners thereon that replaceably holds the at least one encoded tag 16 thereon so as to form a plurality of unique indicia bearing units organized in a selected sequence retained in a book-like holder.

Each encoded tag 16 has a symbolic picture 42 on one side thereof corresponding to a unique identifier encoded into an associated encoded tag 16 that can be read by the at least one tag reader 18 so as to allow the sound of the symbolic picture 42 to be produced, and on the other side thereof, a mating portion 44 of the hook and loop fasteners replaceably attach to the portion 40 of the hook and loop fasteners in the binder 38. Each encoded tag 16 has an individual radio frequency transmitter sending a dedicated radio frequency signal to the at least one tag reader 18 so as to form a wireless, batteryless ID tag readable from and/or written to using a radio-frequency communication protocol, thereby providing wireless communication of stored information.

The interactive speech synthesizer 10 further comprises dip switches 46. The dip switches 46 are disposed at the housing 12 and allow different settings to be configured, such as multiple voices to be associated with the unique identifier of each encoded tag 16 allowing selection of gender and age, thereby making the interactive speech synthesizer 10 more realistic to use for all who may use it.

The housing 12 has a console 48 with recessed areas 50 therein that selectively receive the at least one encoded tag 16, respectively. The recessed areas 50 in the console have the portions 40 of the hook and loop fasteners therein that mate with the mating portion 44 of the hook and loop fasteners of an associated encoded tag 16.

In operation, a user takes desired encoded tags 16 off of the binder 38 and places them in the recessed areas 50 in to console 48, respectively, where they are replaceably attached by the hook and loop fasteners. Once the encoded tags 16 are assembled as desired the user presses an associated activation apparatus 28 in succession, thereby forming a phrase or sentence. As each encoded tag 16 is pressed the at least one tag reader 18 reads and stores the unique identifier of the associated encoded tag 16 to produce associated sounds in sequence, allowing the interactive speech synthesizer 10 to communicate with other people.

It will be understood that each of the elements described above, or two or more together, may also find a useful application in other types of constructions differing from the types described above.

While the invention has been illustrated and described as embodied in an interactive speech synthesizer for enabling people who cannot talk but who are familiar with use of picture exchange communication to autonomously communicate using verbal language, however, it is not limited to the details shown, since it will be understood that various omissions, modifications, substitutions, and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An interactive speech synthesizer for enabling people who cannot talk but who are familiar with use of picture exchange communication to autonomously communicate using verbal language, comprising:
a) a housing;
b) a microcontroller;
c) at least one encoded tag;
d) at least one tag reader; and
e) an audio output device;
wherein said microcontroller, said at least one tag reader, and said audio output device are disposed at said housing;
wherein said at least one encoded tag is replaceably attached to said housing; and wherein said at least one tag reader reads data from an associated encoded tag, which has been replaceably attached thereat, to form a coded signal and transmits said coded signal to said microcontroller that looks up a sound bit file corresponding to said coded signal and sends said sound bit file to said audio output device to convert into sound, thereby allowing a sound corresponding to said selected tag to be produced to thereby generate, automatically and sequentially, unique audible information associated with said data of each encoded tag.

2. The synthesizer of claim 1, wherein each of said at least one tag reader is a coil.

3. The synthesizer of claim 1, wherein said audio output device is a speaker.

4. The synthesizer of claim 1, further comprising memory;
wherein said memory is disposed at said housing; and
wherein said memory stores said sound bit files to be looked up by said microcontroller.

5. The synthesizer of claim 4, wherein said memory stores said sound bit files by addresses.

6. The synthesizer of claim 1, further comprising activation apparatus;
wherein said activation apparatus is disposed at said housing; and
wherein said activation apparatus when activated activates said microcontroller and said at least one tag reader to read said data from an associated encoded tag, thereby triggering said sounds.

7. The synthesizer of claim 6, wherein said activation apparatus is at least one switch.

8. The synthesizer as defined in claim 1, further comprising power management apparatus;
wherein said power management apparatus is disposed at said housing;
wherein said power management apparatus is for interfacing with a power supply; and
wherein said power management apparatus conserves power by allowing said interactive speech synthesizer to remain in sleep mode until activated.

9. The synthesizer as defined in claim 1, further comprising an interface port;
wherein said interface port is disposed at said housing; and
wherein said interface port is for flashing new firmware and downloading new sound bit files into said interactive speech synthesizer.

10. The synthesizer as defined in claim 9, wherein said interface port is a USB port.

11. The synthesizer as defined in claim 1, further comprising a microphone/amplifier;
wherein said microphone/amplifier is disposed at said housing; and
wherein said microphone/amplifier is for recording new sound bit files into said interactive speech synthesizer.

12. The synthesizer as defined in claim 1, further comprising a binder; and
wherein said binder replaceably contains said at least one encoded tag.

13. The synthesizer as defined in claim 12, wherein said binder has a portion of hook and loop fasteners thereon; and
wherein said portion of hook and loop fasteners replaceably hold said at least one encoded tag thereon so as to form a plurality of unique indicia bearing units organized in a selected sequence retained in a book-like holder.

14. The synthesizer as defined in claim 13, wherein each encoded tag has a symbolic picture on one side thereof; and
wherein said symbolic picture corresponds to a unique identifier encoded into an associated encoded tag that can be read by said at least one tag reader so as to allow said sound of said symbolic picture to be produced.

15. The synthesizer as defined in claim 14, wherein each tag has a mating portion of said hook and loop fasteners and on the other side thereof; and
wherein said mating portion of said hook and loop fasteners replaceably attach to said portion of said hook and loop fasteners in said binder.

16. The synthesizer as defined in claim 1, wherein each encoded tag has an individual radio frequency transmitter;
wherein said individual ratio frequency transmitter of each encoded tag sends a dedicated radio frequency signal to said at least one tag reader so as to form a wireless, batteryless ID tag readable from and/or written to using a radio-frequency communication protocol, thereby providing wireless communication of stored information.

17. The synthesizer as defined in claim 14, further comprising dip switches;
wherein said dip switches are disposed at said housing; and
wherein said dip switches allow different settings to be configured,

18. The synthesizer as defined in claim 17, wherein, a setting includes multiple voices to be associated with said unique identifier of each encoded tag allowing selection of gender and age, thereby making said interactive speech synthesizer more realistic to use for all who may use it.

19. The synthesizer as defined in claim 15, wherein said housing has a console; and
wherein said console of said housing selectively receives said at least one encoded tag.

20. The synthesizer as defined in claim 19, wherein said console of said housing has said portion of hook and loop fasteners thereon; and
wherein said portion of hook and loop fasteners mate with said mating portion of said hook and loop fasteners of an associated encoded tag.

21. The synthesizer as defined in claim 13, wherein said console of said housing has recessed areas therein; and
wherein said recessed areas in said console have said portions of said hook and loop fasteners therein.

22. A method of utilizing an interactive speech synthesizer for enabling people who cannot talk but who are familiar with use of picture exchange communication to autonomously communicate using verbal language, wherein said interactive speech synthesizer has a housing with a console with recessed areas, at least one encoded tag, a binder, an activation apparatus, at least one tag reader, said method comprising the steps of:
a) taking desired at least one encoded tag off of the binder;
b) placing the desired at least one encoded tag in the recessed areas in the console of the housing, respectively, where they are replaceably attached by hook and loop fasteners;
c) pressing an associated activation apparatus in succession, thereby forming a phrase or sentence;
d) reading by the at least one tag reader;
e) storing a unique identifier of an associated encoded tag; and
f) producing associated sounds in sequence, allowing said interactive speech synthesizer to communicate with other people.
